(19) United States
(12) Patent Application Publication
(10) Pub. No.: US 2015/0379556 A1
(43) Pub. Date: Dec. 31, 2015

(54) System and Method for Online Advertising

(71) Applicant: Kenshoo Ltd., Tel Aviv (IL)

(72) Inventor: Roy Udassin, Givaataim (IL)

(73) Assignee: KENSHOO LTD., Tel Aviv (IL)

(21) Appl. No.: 14/314,769

(22) Filed: Jun. 25, 2014

(51) Int. Cl. G06Q 30/02

(52) U.S. Cl. CPC G06Q 30/0243; G06Q 30/0269; G06Q 30/0275

(57) ABSTRACT

A system, method and non-transitory media containing instructions for managing a next engagement in a system comprising a memory storing a database of collected users' paths to conversion, the system including a processor operatively coupled to the memory to obtain a pattern comprising one or more interactions, with respect to a user, map the obtained pattern to paths in the database and selecting the paths characterized by a likelihood value fitting a predefined condition, to yield matched paths, select a preferred path from among the matched paths using parameters, and determine an action for the next engagement using business-related criteria, thereby influencing said user to choose a next action corresponding to the selected preferred path.

### FIELD OF THE INVENTION

The present invention relates to real-time online engagements. In particular the present invention relates to bidding for online advertising.

### BACKGROUND

Online advertising inventory can be bought and sold, often in real-time (e.g., via real-time bidding (RTB)) or, in some examples, in near real time. In some examples of RTB, when a user visits a website; a bid request may be automatically triggered and submitted, wherein advertisers or their representatives are requested to bid on the opportunity to place one or more advertisements on the loading website. The submitted bid request can include supporting information, for example, information about the loading page, the user's browsing history, information related to the user's location, demographics, and system loading the website, among other pieces of pertinent or non-pertinent information.

The user visiting the website can, in some examples, be uniquely identified online, for example, via small pieces of code (i.e. cookies) deposited by a web site, that can be stored locally in a user's web browser. The browser can be configured to send that cookie back to a website, each time that website is loaded by the user.

Tracking cookies and third-party cookies, i.e., not deposited by the viewed website, can be configured to collect long-term browsing records of users. Other methods can also be used to track and catalogue the web related history of a user (i.e. fingerprint technology).

Expenditure on real time bidding is expected to continue growing, and to provide a more efficient and direct method of providing ad content to users.

In RTB, in some examples, an ad exchange submits a request for bidding and corresponding supplementary user data to one or more advertisers. The one or more advertisers can submit bids in real time to place an ad as the website is served. The winner, for example, the highest bidder, has their ad placed on the loading webpage. In some examples, this process can be iterative, repeating for example, for every ad position on a webpage. In some examples, the entire transaction can take a fraction of a second.

In some examples, publishers can provide an inventory of potential ads to the Ad Exchange and employ demand side platforms (DSPs) on behalf of the advertisers to place a bid for one or more impressions on the loading page. In other examples, the DSP may also generate one or more ads.

In online advertising, a user may be presented with numerous ads on multiple sites before a conversion takes place, e.g., before the user actually buys the advertised product.

Advertisers can set complex criteria for use in the autonomous and automatic real time bidding process. In some examples, an advertiser may decide on a course of action, e.g., an engagement, or a non-engagement, or another action, based on the likelihood of a subsequent event following the advertiser's course of action and the actual or likely response by the user to the advertiser's course of action. The action in some examples, may not necessarily be an action, and may be, in some examples, the refraining from taking an action. The likelihood of an eventual user action may be discernible with some probability, given past events; e.g., a conditional probability.

### BRIEF DESCRIPTION

According to one aspect of the presently disclosed subject matter there is provided a method of managing a next engagement of a user, the method comprising using a processor operatively coupled to a memory storing a database of collected users' paths to conversion, the processor configured to obtain a pattern comprising two or more interactions, with respect to a user, compare the obtained pattern to patterns leading to conversion in the database, and to select one or more matching paths from the patterns leading to conversion and to determine an action for the next engagement, the action for the next engagement configured to influence the user to choose a next action corresponding to an interaction in at least one of the selected matching paths.

In accordance with an aspect of the presently disclosed subject matter, there is yet further provided, the method wherein the selection of one or more matching paths further comprises using one or more clustering functions.

In accordance with an aspect of the presently disclosed subject matter, there is yet further provided, the method wherein the one or more clustering functions are configured to cluster said obtained pattern with data, the data selected from the group consisting of data associated with a user path, data associated with an advertiser's product, data associated with a user, data associated with a prior history of the user, and data associated with a proximity of a user to a predefined zero moment of truth.

In accordance with an aspect of the presently disclosed subject matter, there is yet further provided, the method wherein the processor selects a path from among the one or more matching paths using one or more parameters.

In accordance with an aspect of the presently disclosed subject matter, there is yet further provided, the method wherein the parameters comprise parameters selected from a group of conversion values, probabilistic conversion times, conversion types, and probability of conversion.

In accordance with an aspect of the presently disclosed subject matter, there is yet further provided, the method wherein the processor selects from the patterns in the database one or more matching paths using one or more clustering functions and using one or more parameters to extract one or more matching paths from a cluster.

In accordance with an aspect of the presently disclosed subject matter, there is yet further provided, the method wherein the determination of an action for the next engagement is in view of commercially relevant parameters.

In accordance with an aspect of the presently disclosed subject matter, there is yet further provided, the method wherein an action for the next engagement includes modifying a bid.

In accordance with an aspect of the presently disclosed subject matter, there is yet further provided, the method wherein the determination of an action for the next engagement includes modifying a channel of an advertisement to a mobile channel.

In accordance with an aspect of the presently disclosed subject matter, there is yet further provided, the method wherein the determination of an action for the next engagement includes modifying an advertisement presented to the user.

In accordance with an aspect of the presently disclosed subject matter, there is yet further provided, the method wherein modifying the advertisement presented to the user includes modifying one or more aspects of the advertisement, the aspects selected from the group consisting of creative, type, channel and targeting.

In accordance with an aspect of the presently disclosed subject matter, there is yet further provided, the method wherein the next engagement depends on a lifetime value of the user to an advertiser.

There is further provided, in accordance with an aspect of the presently disclosed subject matter, one or more non-transitory computer-readable media storing computer-readable instructions to manage a next engagement in a system comprising a memory storing a database of collected users' paths to conversion that, when executed by a processor, cause the processor to obtain a pattern comprising two or more interactions, with respect to a user, compare the obtained pattern to patterns leading to conversion in the database, and to select one or more matching paths from the patterns leading to conversion, and, to determine an action for the next engagement, the action for the next engagement configured to influence the user to choose a next action corresponding to an interaction in at least one of the selected matching paths.

In accordance with an aspect of the presently disclosed subject matter, there is yet further provided, the one or more non-transitory computer-readable media storing computer-readable instructions further causing the processor to select from the patterns in the database one or more matching paths using one or more clustering functions.

In accordance with an aspect of the presently disclosed subject matter, there is yet further provided, the one or more non-transitory computer-readable media storing computer-readable instructions further causing the processor to cluster the one or more clustering function groups of said obtained pattern with data, the data selected from the group consisting of data associated with a user path, data associated with an advertiser's product, data associated with a user, data associated with a prior history of the user, and data associated with a proximity of a user to a predefined zero moment of truth.

In accordance with an aspect of the presently disclosed subject matter, there is yet further provided, the one or more non-transitory computer-readable media storing computer-readable instructions further causing the processor to select a path from among the one or more matching paths using one or more parameters.

In accordance with an aspect of the presently disclosed subject matter, there is yet further provided, the one or more non-transitory computer-readable media storing computer-readable instructions further causing the processor to use parameters comprising parameters selected from a group of conversion values, probabilistic conversion times, conversion types, and probability of conversion.

In accordance with an aspect of the presently disclosed subject matter, there is yet further provided, the one or more non-transitory computer-readable media storing computer-readable instructions further causing the processor to determine that an action for the next engagement is in view of commercially relevant criteria.

In accordance with an aspect of the presently disclosed subject matter, there is yet further provided, the one or more non-transitory computer-readable media storing computer-readable instructions further causing the processor to modify a bid in the next engagement.

In accordance with an aspect of the presently disclosed subject matter, there is yet further provided, the one or more non-transitory computer-readable media storing computer-readable instructions further causing the processor to modify an advertisement presented to the user.

In accordance with an aspect of the presently disclosed subject matter, there is yet further provided, the one or more non-transitory computer-readable media storing computer-readable instructions further causing the processor to, modify the advertisement presented to the user by modifying one or more aspects of the advertisement, the aspects selected from the group consisting of creative, type, channel and targeting.

In accordance with an aspect of the presently disclosed subject matter, there is yet further provided, the one or more non-transitory computer-readable media storing computer-readable instructions further causing the processor to, modify the advertisement presented to the user by modifying a channel of an advertisement to a mobile channel.

In accordance with an aspect of the presently disclosed subject matter, there is yet further provided, the one or more non-transitory computer-readable media storing computer-readable instructions further causing the processor to determine the next engagement depending on a lifetime value of the user to an advertiser.

There is further provided, in accordance with an aspect of the presently disclosed subject matter, a system configured to manage a next engagement of a user, the system comprising a processor, the processor operatively coupled to a memory storing a database of collected users' paths to conversion, and configured to obtain a pattern comprising two or more interactions, with respect to a user, compare the obtained pattern to patterns leading to conversion in the database, and to select one or more matching paths from the patterns leading to conversion, and to determine an action for the next engagement, the action for the next engagement configured to influence the user to choose a next action corresponding to an interaction in at least one of the selected matching paths.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is a functional schematic diagram of a path to conversion generator in a system for online bidding, according to an example;

FIG. 2 is an example of a history of interactions as used by a path to conversion generator, in a system for online bidding, according to an example;

FIG. 3 is a generalized flow chart of a method for determining the action for a next engagement in a system for online bidding, according to an example; and,

FIG. 4 is a schematic representation of a clustering of the obtained pattern to paths in the database in a system for online bidding, according to an example.

### DETAILED DESCRIPTION

In the following detailed description, numerous specific details are set forth in order to provide a thorough understanding of the systems, methods and apparatus. However, it will be understood by those skilled in the art that the present systems, methods and apparatus can be practiced without some or all of these specific details. In other instances, well-known methods, procedures, and components have not been described in detail so as not to obscure the present methods and apparatus.

Although the examples disclosed and discussed herein are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like.

Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

The term “computer”, “computer processor”, “processor” or the like should be expansively construed to cover any kind of electronic device with data processing capabilities, including, by way of non-limiting example, a processor, a path-to-conversion generator or any combinations thereof disclosed in the presently disclosed subject matter.

The operations in accordance with the teachings herein can be performed by a computer specially constructed for the desired purposes or by a general purpose computer specially configured for the desired purpose by a computer program stored in a computer non-transitory computer readable media, and/or computer readable instructions.

It is appreciated that certain features of the presently disclosed subject matter, which are, for clarity, described in the context of separate embodiments, can also be provided in combination in a single embodiment. Conversely, various features of the presently disclosed subject matter, which are, for brevity, described in the context of a single embodiment, can also be provided separately or in any suitable sub-combination.

It is also to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the present presently disclosed subject matter.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

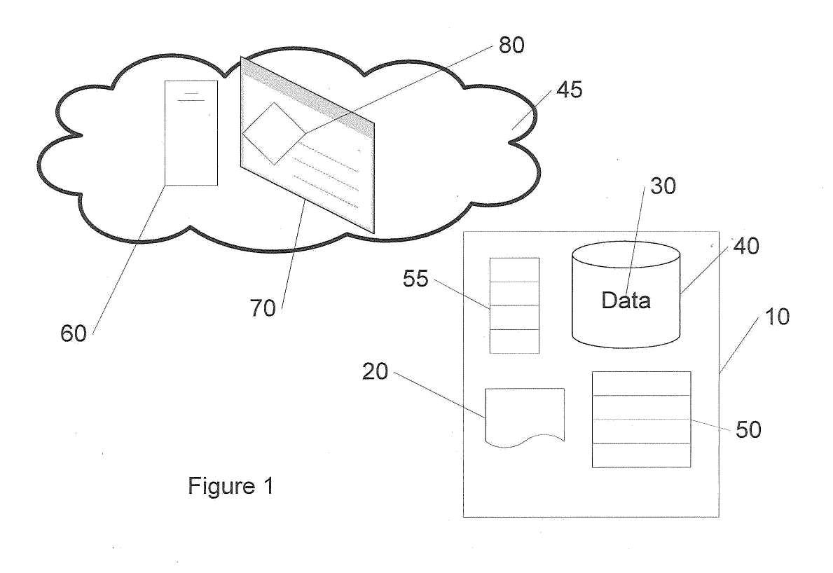

FIG. 1 is a functional schematic diagram of a path to conversion generator in a system for online bidding, according to an example.

In some examples, a path to conversion will include a user. A user can be, for example, a human user (e.g. identified by a unique identifier such as for example, a social security number or username), and may also be a computer, a processor or other electronic communication device (e.g. identified by its Internet protocol (IP) address, its media access control (MAC) address, a cookie installed on it, and/or other identification methods).

In some examples, a path to conversion can include an online ad entity or ad entity. An ad entity may relate to an individual ad, or, alternatively, to a set of individual ads, for example, run by an advertising platform. An individual ad may include an ad copy, which is the text, graphics and/or other media to be served (displayed and/or otherwise presented), to the user.

An individual ad may include and/or be associated with parameters, such as searched keywords to target, geographies to target, demographics to target, a bid for utilization of advertising resources of the advertising platform, and/or the like. In some examples the bid may set for a particular parameter instead of or in addition to setting a global bid for the ad entity; for example, the bid may be per keyword, geography and/or other parameters.

A path to conversion can be a path of interactions between an ad entity and a user that is intended to end, at a predetermined or non predetermined time frame in a conversion, where a conversion can include a purchase of a product, a signing up for a service, or an account. Conversions can also include, for example, joining a mailing list, voting in a survey, “Like”-ing, “+1”-ing or “Tweet”-ing a page on a website, “Like”-ing a page on Facebook and so on, and usually correspond to an advertiser goal. The series of interactions may not include all of the interactions of an advertising entity with the user. Some interactions may be irrelevant (e.g., the user may have searched for several unrelated products but only some of these interactions are relevant for an optional future purchase of a selected one of them), while some of the interactions may be unaccounted for (e.g., the user may have seen a billboard advertisement of the marketer, or has seen another person using the product).

A path to conversion may also include a series of interactions, e.g., user interactions. A path to conversion may include non-interactions and/or other user or non-user events. The series of user interactions (also referable to as “paths”) may include some or all of the interactions (for which data exists) with a single user (or with multiple users, especially of those which are related to each other, e.g., via one of the interactions). Other grouping conditions may also be applied: For example, the series may be limited only to interactions which occurred within a predefined time frame, only to interactions over preselected channels such as, for example a mobile channel, only to interactions pertaining to a subgroup of advertised products but not to others, and so on.

In some examples, interactions can also include communication of digital media over a network or other type of connection. Such interactions may include the previously offered examples or other types of interactions such as clicking or viewing by the user of a digital media advertisement, digital purchase of a product, and possibly digital transaction (e.g. provisioning of a purchased mp3 file), signing-in to a website or a service, social media interactions, e-mails, television advertisements, smart TV advertisements, and/or other interactions.

In FIG. 1, a path to conversion system 10 can include a processor 20. Processor 20 can be configured to calculate probabilities relating to a user's future actions. Processor 20 can be operatively coupled to a memory device, e.g., a memory module 40. Processor 20 can be operatively coupled to a database 30. Database 30 can be a database of collected users' paths, as described herein. Database 30 can be stored in memory module 40; database 30 can be stored locally and/or remotely. Database 30 can be a third party database with full or limited access for reading and/or writing.

Database 30 can be dynamic. Database 30 can include data describing a user, wherein a user can be defined generally as a particular demographic, the particular demographic can be definable by one or more overlapping and or non-overlapping criteria, including for example, age, gender, marital status, location, income, education, sexual orientation, and other criteria. In some examples a user can be definable generally by an end goal, for example a user can be definable as a person who purchases a particular product and/or a particular service. In some examples a user can be definable as a particular individual, known or unknown. Database 30 can include identifying information that can, with some degree of certainty, identify a user, for example, via a cookie or other tracking technology.

In some examples, one or more of the components described hereinabove can be operatively coupled to one or more components described or not described via wired and/or wireless connection, directly or indirectly (e.g. via cloud), and/or coupled to a third party device or system.

In some examples, path to conversion system 10 can include parameters 50. Parameters can be provided from an advertiser. In some examples, the parameters from an advertiser can be dynamic or fixed. In some examples parameters 50 can be a set of parameters. Parameters 50 can be provided by the advertiser, a third party, generated internally, or by anyone else. Parameters 50 can be stored locally, remotely, and/or with a third party. Parameters 50 can be stored within memory module 40.

Parameters 50 can include, for example, conversion values, probabilistic conversion times, conversion types, and probability of conversion. Parameters 50 can be related generally to the chance that a user will choose a result, based on prior knowledge relating to the user, the user's demographics, and/or the result.

In some examples, path to conversion system 10 can include a set of, or, for example one or more, commercially relevant criteria 55. Business-related criteria may be provided from an advertiser. In some examples, business-related criteria 55 from an advertiser can be dynamic or fixed.

Business-related criteria 55 can include, for example, the short and/or long term goals of the advertiser, bidding parameters, lifetime value, or expected lifetime value of a user to the advertiser, goals of the advertiser with regard to a temporal period overlapping or not overlapping with the present, type of advertising considered by the advertiser, and its relevance to the user. Business-related criteria 55 can be provided by the advertiser, a third party and/or anyone else. Business-related criteria 55 may be directly related to the advertisement, may be indirectly related to the advertisement, or may be related to a business objective of the advertiser independent of the advertisement. In some examples business-related criteria 55 may be only somewhat related to any business of the advertiser, the user or a third party. In some examples, business-related criteria 55 may be not obviously business-related.

In some examples, database 30 can include one or more types of compiled users. In some examples, database 30 can include patterns of said users. In some examples, the patterns of users can include pathways and/or funnels to conversions.

In some examples, path to conversion system 10 can be connected wirelessly or via a wired connection to the Internet 45. In some examples, path to conversion system 10 can be connected to an intranet.

In some examples, path to conversion system 10 can collect information from a target user 60. Target user 60 can be an individual. Target user 60 can be a group of individuals that share a computer. Target user 60 can be a computer, IP address, or other uniquely identifiable person or device.

Target user 60, when presented with a webpage 70 can be presented with an advertisement 80 on page 70. In some examples, path to conversion system 10 can include a component, for example, a processor, or be connected to an internal or external component for example, a processor, configured to bid, or refrain from bidding, or placing an advertisement 80 on webpage 70.

Said bidding, in some examples, can be associated with, or varied, due to determinations related to target user 60 and/or assumptions of target user's intentions and/or probable actions in light of current and future events, given a priori and other data.

The disclosures of all publications and patent documents mentioned in the specification, and of the publications and patent documents cited therein directly or indirectly, are hereby incorporated by reference. For example, US applications assigned to the Assignee, Kenshoo Ltd., of the present application, are incorporated herein by reference.

The applications, including, for example, U.S. patent application Ser. No. 13/369,621, “System, a method and a computer program product for performance assessment” to Armon-Kest et al., describing a system, a computerized method, and a computer program product for classification of items based on their attributes and on a classification scheme that is defined based on information pertaining to each item of a set of items, and which is indicative of: (a) a quantity of occurrences of the item in a sample; (b) a quantity of successful occurrences of the item in the sample; and (c) at least one attribute of the item with regard to at least one variable out of a set of variables;

U.S. patent application Ser. No. 14/018,669, “A System, A Method And A Computer Program Product For Optimally Communicating Based On User's Historical Interactions And Performance Data” to Armon-Kest et al., describing a system for communication, comprising: a non-transitory processor configured to: (a) determine a group of messages comprising a plurality of optional messages for a user in response to obtaining of user identification information identifying the user; (b) obtain performance information for each one of plurality of optional messages; (c) obtain historical interactions data pertaining to interactions which are included in a series of user interactions, wherein at least one of the interactions of the series comprises communication of digital media over a network connection to the user; and (d) select an elect message out of the plurality of optional messages based on the historical interactions data and on the performance information; and a communication interface operable and configured to transmit information of the elect message over a communication channel;

U.S. patent application Ser. No. 13/598,925, “System, method and computer program product for attributing a value associated with a series of user interactions to individual interactions in the series”, to Synett et al. describing a system operable to attribute a value associated with a series of user interactions to individual interactions in the series, the system including: (a) an interface, configured to obtain information of interactions which are included in the series of interactions; and (b) a processor on which an attribution module is implemented, the attribution module is configured to attribute an apportionment of the value to each out of a plurality of interactions of the series, based on a calibrated attribution scheme and on properties relating to at least one interaction out of the series of interactions, thereby enabling efficient utilization of communication resources;

U.S. patent application Ser. No. 13/692,071, “System, method and computer program product for prediction based on user interactions history”, to Synett et al., describing a system operable to computing a performance assessment, the system including: an interface, configured to obtain information of interactions which are included in a series of interactions, wherein at least one of the interactions of the series includes communication of digital media over a network connection; and a processor on which a performance assessment module is implemented, the performance assessment module is configured to compute a performance assessment for the series of interactions, based on the obtained information and on an assessment scheme which is based on a statistical analysis of historical data of a plurality of series of interactions;

U.S. patent application Ser. No. 14/068,108 “Method for Efficiently Allocating an Advertising Budget Between Web Advertising Entities” to Aronowich et al, describing a computing system capable of allocating an advertisement budget of an advertisement campaign between a plurality of advertisement entities and a method of operating thereof. The method comprises: obtaining, for each of the plurality of advertisement entities, a respective optimal target frontier function representing for each given advertising cost an optimal value of return and configured to follow the law of diminishing return; receiving a budget constraint for the advertisement budget; generating a global target frontier function by summing each of the received optimal target frontier functions; processing the generated global target frontier function to determine for each of the plurality of advertisement entities an optimal, with respect of at least the received budget constrain, advertising cost value such that a sum of the optimal advertising cost values meets the budget constraint; and reporting the determined values;

U.S. patent application Ser. No. 13/913,551 “Identifying a Non-obvious Target audience for an Advertising Campaign” to Sadeh et al., describing a method system and computer program product for identifying candidate topics for the allocation of advertising resources, for identifying candidate topics for the allocation of advertising resources by calculating a relevance value of a candidate topic with respect to a base topic as a function of a number of individuals that is associated with the base topic, a number of individuals that is associated with the candidate topic, and a number of individuals that is associated with both the base topic and the candidate topic, determining that the relevance value of the candidate topic is above a predefined threshold, and identifying the candidate topic as a target for an advertising resource.

The applications, incorporated by reference, teach, for example, many principles of path-to-conversion analysis that are applicable to the presently disclosed subject matter. Therefore the full contents of these publications are incorporated by reference herein for appropriate teachings of additional or alternative details, features and/or technical background.

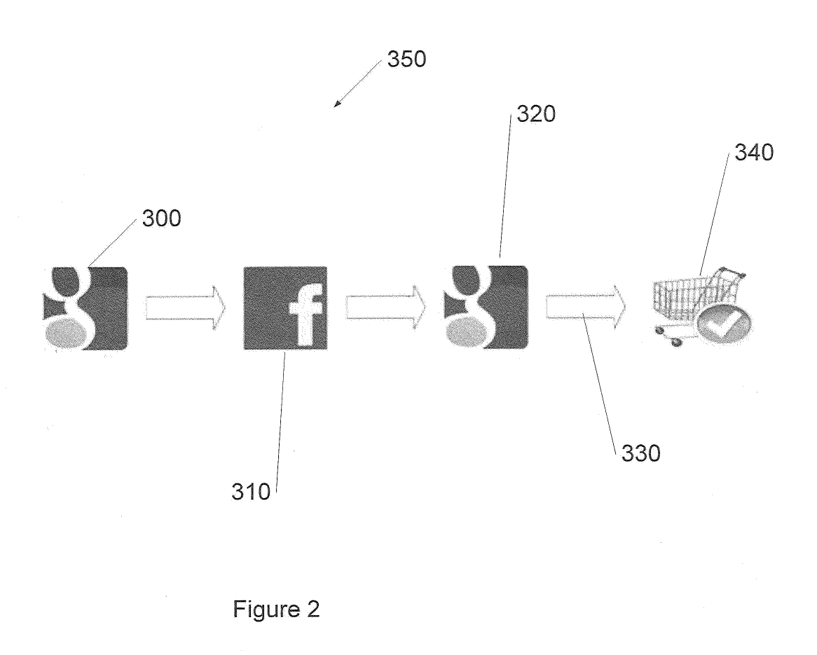

FIG. 2 is an example of a history of interactions as used by a path to conversion generator, in a system for online bidding, according to an example.

A user, for example the target user described above, can interact with one or more websites online. A user may, after starting on a landing page, and/or another website, follow a path to conversion, e.g., a path to a desired action by said user. This desire and/or target action can, in some examples, trigger a conversion by said user, where the conversion can be a purchase, a sign up, a payment and/or other desired action of a user. The desired action by a user can be in reference to an advertiser, the advertiser can be an advertiser or another entity with a commercial or non commercial scope. The path to conversion can be a conversion funnel and/or another track of a consumer and/or user through the Internet, for example via commercial websites, social media site, search engines and other sites. In some cases, that path to conversion may include more than a single user, for example, a first user may affect (i.e. through social networks) a second user's engagements which may include a purchase (conversion)—this may occur as a result from what is known in the industry as “earned media”.

The path to conversion can include a series of events or interactions. In some examples, each event and/or interaction can be partially responsible for an eventual conversion. In some examples, each event and/or interaction can have an associated attribution, e.g., the appropriate, or an approximation of the appropriate credit for a future conversion.

A path to conversion can include one or more interactions and at least one conversion. A path to conversion can include a non-conversion, an aborted conversion and/or other endpoints.

An interaction can include any engagement of a user with an ad entity, when such interaction may be one or more of the following: clicking by the user on an advertisement provided by a search engine; clicking on an advertisement on a social media network; clicking on an advertisement on a webpage; clicking on an advertisement presented to a user during a search; clicking on an advertisement presented to a user on any website; clicking on an advertisement presented to a user via an email or a text message or an SMS, or any other form of communication via media including microblogs; clicking on an advertisement presented to a user via a mobile application, app, widget or other software; clicking on an advertisement presented to a user during a software install and/or uninstall; viewing an advertisement (also known as “impression”); interacting with an advertisement via a user input, including a keyboard, a mouse, a pointing device, a sensed motion, and/or other inputs.

A conversion as described for example herein and above, generally refers to an interaction of a user that creates or is associated with a value to an advertiser, and can include, online purchase, online registration, downloading a mobile application, in-app purchase, social network interactions (including, for example, liking, upvoting, downvoting, commenting, clicking, forwarding and/or other social network interactions); clicking on a link within an email, text message, SMS, or other message sent to a user; playing a promotional video; playing a promotional game; using a location based social networking tool; retweeting; resending and/or other interactions, electronic, web based, or otherwise.

A user as described for example herein and above, can include a person, a bot, a computer system, and/or any medium capable of conducting an interaction, manually, semi automatically and/or automatically.

In some examples, a path can represent a series of interactions that a user carries out during stages of an eventual conversion, for example, path 350. Path 350 is a representative path. In some examples, a path can be shorter. In some examples, a path can be longer. In some example, a path can bifurcate, or divide into multiple parallel or nonparallel paths. In some examples, a path can include irrelevant interactions with regard to a conversion. In some examples, the path can include irrelevant and/or relevant tangents, and/or other components. In some examples, a path can include only relevant interactions with regard to a conversion.

In some examples a user can interact with a first web site, for example, a landing page, or other form of interaction, as depicted by a representative web search icon of website 300.

In some examples, a user can conduct one or more interactions on a web site. In some examples, a user can conduct only a single interaction on a website. In some examples, the lack of a user interaction on a web site can be part of pathway 350. In some examples, a failed attempt at an interaction can be considered an interaction.

In some examples, the user can be tracked on a pathway. The user can be tracked on pathway 350 via one or more cookies. The user can be tracked on a pathway via a JavaScript or via other tracking methods.

A user can interact with another website 310. The other website 310 can be a social media website, for example as depicted. The user may have reached website 310 as a result of an interaction on website 300. In some examples the user may have reached website 310 via a circuitous route, the circuitous route as a result of an interaction on website 300. The circuitous route can be independent of an interaction on website 300. Website 310 can be similar to website 300. Website 300 can be different than website 310, for example as depicted in the figure.

A user can interact with an additional one or more websites, for example website 320. A pathway can lead to conversion 340, a conversion, for example, as described above. A pathway can lead to conversion 340 directly, for example as depicted via arrow 330, or indirectly.

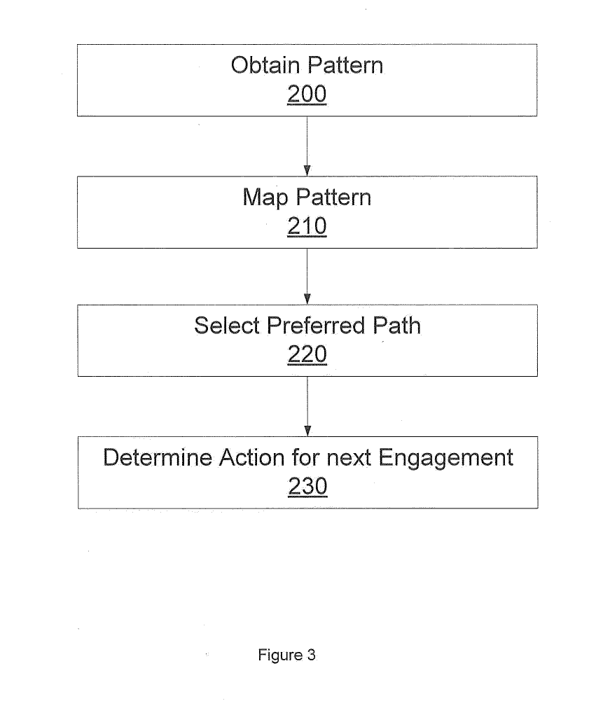

FIG. 3 is a generalized flow chart of a method for determining the action for a next engagement in a system for online bidding, according to an example.

In some examples, a path to conversion generator can be configured to manage a next engagement wherein an engagement can be an interaction, for example as described above, a conversion, for example as described above, and/or another action relating to a user, for example the user, as described above. The next engagement can be generated in real-time or near real-time, and may be generated by a communication from an advertising platform (for example, in an RTB advertising scheme).

The path to conversion generator can be configurable to obtain a conversion for an advertiser. The path to conversion generator can be configured to run on a processor, and the processor can be configured to only run the path to conversion generator. The processor may not be configured to only run the path to conversion generator. The processor can be configured to be wirelessly connected to one or more memory modules, and the one or more memory modules can comprise a database. The processor can be coupled via a wired or other connection to said memory modules. The processor can be operatively coupled to memory.

The processor can be configured to obtain a dataset, which can include a seed path, the seed path comprising two or more interactions of the user, e.g., a history of interactions of a user and/or the obtained pattern of the user, for example, as depicted in box 200. The history of interactions of a user can comprise a single interaction. The history of interaction can comprise multiple interactions. The seed path can include, for example, the interactions themselves (e.g., with associated metrics, time and other metrics) and the “path” between each on the interactions, the path including the time from one to interaction to another, and any changes in browser, devices, and/or other parameters associated with the user's interaction with the Internet. The history of interactions can also include the pattern of the entire path. The history of interactions of a user can be determinable via a cookie and/or other tracking methods.

The processor can be further configured to compare the seed path with the patterns in the database. The patterns in the database can include one or more paths to conversion. The patterns in the database can include paths that have led to a conversion.

In some examples, the processor can map the seed path to one or more goal paths in a database, for example, a database of collected user paths, as depicted in box 210. In some examples, the seed path can be mapped to a set of paths in the database, the mapping based on one or more parameters. For example, the seed path can be mapped to one or more patterns of the same user. In some examples, the seed path can be mapped to one or more patterns of a similar user. In some examples a similar user can be a user within a similar demographic, and said demographic can be definable by age, purchasing power, level of education, national origin, race, sex, and/or other demographics. The pattern can be mapped to one or more paths, wherein said paths result in a conversion desired by an advertiser. The pattern can be mapped to one or more paths wherein said one or more paths can be associated with a product or a commodity. The paths can be determinable based on data from a user or a prior history of a user.

In some examples, the mapping process of the seed path onto the database can be made more efficient by extracting from the set of paths in the database, a smaller subset, from within the database of goal paths. These goal paths can represent a subset of paths within the database that contain similarities with the seed path, or the goal of the advertiser interested in the user associated with the seed path.

The pattern can be mapped to a smaller subset of paths via a mathematical, statistical, or other process, the mapped patterns then being selected for further analysis. The process can include a clustering function, or a plurality of clustering functions. The process can be iterative and can use machine learning techniques. The process can use a plurality of techniques for determining a match or near match to the user's path. The process can be automatic, semi automatic and/or manual. The processor can be configured to conduct said process in a fraction of a second. In some examples, the process to map the obtained pattern to paths in the database and to select the paths characterized by a likelihood value fitting predefined conditions to yield matched paths, may include predefined conditions to direct the clustering function. Predefined conditions can be provided by a third party, generated internally, or provided by an advertiser. Predefined conditions may be dependent on the user, the importance of the user, and the conversion of the user to the advertiser. Predefined conditions can be dependent on the database of paths, the demographics of the user, the amount of data available regarding the user, the amount of data in the database, the nature of the data relating to the user, the nature of the data in the database, and/or other conditions.

In some examples, wherein the mapping process uses a clustering function, one or more paths from said database may be selected, wherein the selection is characterized by a likelihood value. In some examples, the path chosen may not be the most likely path. In some examples, the path chosen can be the path desired by the advertiser. In some examples, the path can be chosen based on other criteria, thresholds and other parameters.

In some examples, the clustering in the mapping process of the seed path onto paths in the database can be with data selected from the group of data associated with a user path, data associated with an advertiser's product, data associated with a user, and/or data associated with a prior history of the user. For example, the clustering may be done according to paths to conversion analysis which assigns a value to each cluster according to the stage in which the user is in relation to a predefined, or otherwise characterized “zero moment of truth” (ZMOT) criteria, e.g., a predefined zero moment of truth (predefined ZMOT), namely the proximity to a critical point in the purchasing funnel where a purchase decision is made, or not made.

In some examples, the selection can be characterized by a likelihood value and one or more predefined criteria. The likelihood value can be within a threshold, the threshold as defined by an advertiser, or otherwise defined. The likelihood value can be within a fixed or dynamic threshold.

The likelihood value can be used by one or more processors to match paths within said database with said pattern. The likelihood value can be used to match one or a plurality of paths from said database.

A preferred path can be selected from the one or more matches, for example, as depicted in box 220. Said preferred path may not necessarily be the path with the highest likelihood of conversion. Said preferred path can be selected based on parameters. In some examples the parameters can be provided by an advertiser.

In some examples the parameters can include a lifetime value of the user, for example, the entire revenue or profit over time which is predicted for a certain user from future interactions with ad entities of the advertiser. In some examples, the parameters can be associated with revenue and/or other business concerns of an advertiser. In some examples, the parameters can be associated with a desired outcome or conversion. In some examples, the parameters can be associated with the time of the conversion or time scope of the conversion (e.g., end of business, next day, next 5 days, next 24 hours, during December 15-31, during holiday seasons, and/or other dates and times). In some examples, the parameters can be independent of the advertiser, the desired outcome or conversion.

In some examples, the parameters can comprise parameters selected from the group of conversion values, probabilistic conversion times, conversion types, and probability of conversion.

The processor can be configured to further select from the subset of paths in the database, wherein the subset of paths in the database has been determined by a clustering function for example as described above, a further extraction to a smaller subset based on parameters, for example as described above, and/or in view of commercially relevant parameters. The commercially relevant parameters can include, for example, a desired return on investment, profitability, quotas, time constraints, supply, demand, revenue concerns, and/or other commercially related criteria. The commercially related criteria can, in some examples, be provided by the advertiser.

The processor can be configured to further select from the subset of paths in the database a path that includes a possible action for the next engagement, wherein the action for the next engagement can be configured to influence the user to choose a next action, e.g., a desired action, such a desired action corresponding to one of the interactions in at least one of the selected matching paths. In some examples, by influencing the user to choose an interaction corresponding to an action in one of the selected matched paths, the system may be further influencing the user to continue on a path toward a conversion, or toward another desired event. In some examples, the path down which the user is influenced to continue can be a path determined via one or more criteria, parameters, and/or other factors.

A processor can be configured to determine an action for a next engagement, for example a bid decision and/or interaction with the user, as depicted in box 230. The determination of the action can be based on one or more rules, which can be fixed or dynamic, for example the parameters and commercially relevant criteria described above. The determination can be based on an event probability, e.g., the probability of a desired or undesired event and/or a conversion probability, e.g., the probability of a conversion at one time period and/or at a desired time period.

The action for the next engagement can be configured to influence a user to choose a next engagement corresponding to a selected preferred path.

In some examples, the action for the next engagement can include a decision to bid or not to bid on an ad placement. In some examples the action for the next engagement can include placing a bid at a certain value or changing a bid on an ad placement. In some examples, the action for the next bid can include changing, modifying or altering the bid, the nature of the bid, the timing of the bid, the structure of the bid, the financing of the bid, the strategic goals of the bid, stopping the bid, putting a hold on the bid, and other aspects associated with the bid.

In some examples, modifying the advertisement in the next engagement can include changing the creative features of the advertisement. Creative features can include the advertisement's design, font, logo, color, and other visual and/or other creative features of the advertisement. In some examples modifying the advertisement in the next engagement can include not changing the creative features.

In some examples modifying the advertisement in the next engagement can include changing the type of the advertisement, including changing the advertisement to a video advertisement, a game advertisement, a flash advertisement, a banner advertisement, a Facebook advertisement, a social media advertisement, a search advertisement, and other types of advertisements. In some examples modifying the advertisement in the next engagement can include not changing the type of advertisement.

In some examples, modifying the next engagement can include changing the number and/or page placement of the advertisement. In some examples, modifying the advertisement in the next engagement can include not changing the number and/or page placement of the advertisement.

In some examples, modifying the advertisement in the next engagement includes changing the channel of the advertisement, including changing the channel to search, social, display, email, or other types of advertising channels. In some examples, modifying the advertisement in the next engagement can include not changing the channel.

In some examples, modifying the advertisement in the next engagement can include modifying the targeting nature of the advertisement, including modifying the age target, the demographic target, the gender target, the sexual orientation target, the location target, and/or other targeting natures of the advertisement. In some examples, modifying the advertisement in the next engagement can include not modifying the targeting nature of the advertisement.

In some examples, modifying the advertisement in the next engagement can include modifying any other aspect of the ad entity, triggering one or more activities in another advertising channel ceasing to target a user, ceasing the advertising activity changing the targeting to another device of the same user (e.g., from a desktop to mobile computing platform) or to other devices which may be as connected indirectly to the user (e.g. a device of a family member), refresh ads, toggle ads, change type of ads (for example, from audio to video), change placement of ad, and/or other changes or modifications to the nature of the interaction with the user.

In some examples, the next engagement includes installing a cookie on the user's browser, a pixel on the website, or other action to enable tracking capabilities.

In some examples, the system can be configured to collect data from a website or another location of the engagement, or from a website when collecting the user's path, depending on an API for said website.

In some examples, the system can be configured to iteratively match a user's path after each engagement and/or other actions by the user.

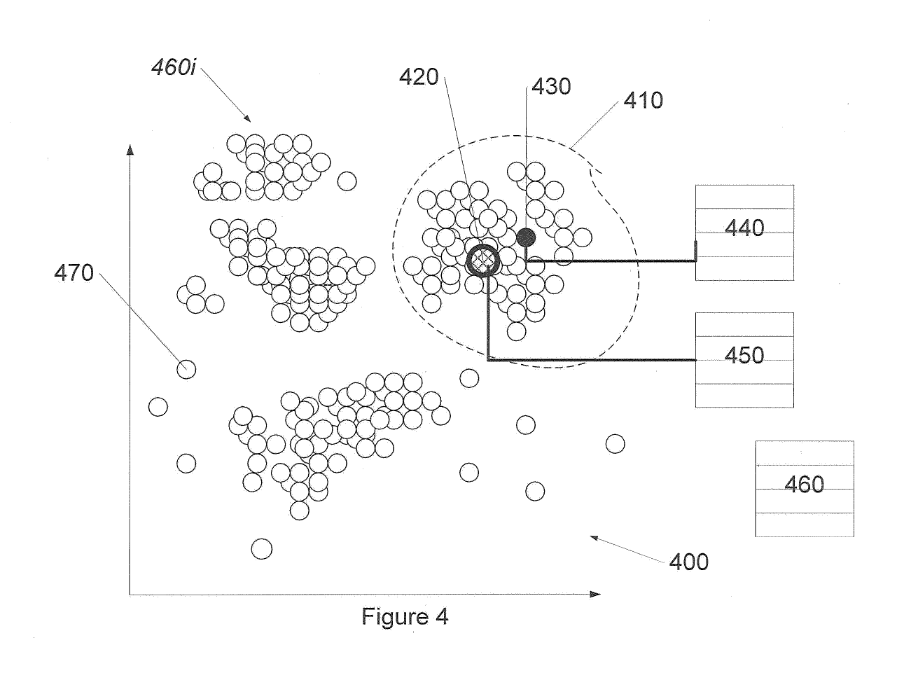

FIG. 4 is a schematic representation of a clustering of the obtained pattern to paths in the database in a system for online bidding, according to an example.

A clustering algorithm is represented pictorially on scatter plot 400. Scatter plot 400 can be two dimensional or multidimensional. Scatter plot 400 can be a representation of paths, the representation not necessarily defined by a scale. Potential matching, relevant, and irrelevant and other paths are represented for example, by circles 460i. One or more clustering algorithms, for example, hierarchical clustering models, k-means clustering algorisms statistical distribution models, fuzzy clustering, single-linkage clustering, Expectation-Maximization clustering, Density-based clustering, complete linkage clustering, average linkage clustering and or other models, algorithms and methods may be used, for example by a processor, for example the processors described above.

A user's pattern 420, representing one or a plurality of interactions, for example interactions as described above, is represented by the circle with the hatched pattern. User's pattern 420 can have values, parameters and other data associated with it, for example as depicted by list 450. User's pattern 420 can be clustered such that paths that are most similar to user's pattern 420 fall within cluster 410. Some paths, e.g., path 470 in a database of paths, queried by the processor, may not fall within any cluster or within cluster 410 containing user pattern 420.

A matching path 430 defined, in some examples, by parameters and other data 440, to user's pattern 420 is represented by a black circle. Matching path 430 may not necessarily be the path most closely matching user's pattern 420. Matching path 430 can have values associated with the path; the values can match an advertiser's desired parameters 460.

It is to be understood that the system according to the presently disclosed subject matter can be a suitably programmed computer. Likewise, the presently disclosed subject matter contemplates a computer program being readable by a computer for executing the method of the presently disclosed subject matter.

The presently disclosed subject matter further contemplates a machine-readable memory tangibly embodying a program of instructions executable by the machine for executing the method of the presently disclosed subject matter.

It is also to be understood that the presently disclosed subject matter is not limited in its application to the details set forth in the description contained herein or illustrated in the drawings.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed:

1. A method of managing a next engagement of a user, the method comprising:
using a processor operatively coupled to a memory storing a database of collected users' paths to conversion, the processor configured to:
obtain a pattern comprising two or more interactions, with respect to a user;
compare the obtained pattern to patterns leading to conversion in the database, and to select one or more matching paths from the patterns leading to conversion; and,
to determine an action for the next engagement, the action for the next engagement configured to influence the user to choose a next action corresponding to an interaction in at least one of the selected matching paths.

2. The method of claim 1 wherein the selection of one or more matching paths further comprises using one or more clustering functions.

3. The method of claim 2 wherein the one or more clustering functions are configured to cluster said obtained pattern with data, the data selected from the group consisting of data associated with a user path, data associated with an advertiser's product, data associated with a user, data associated with a prior history of the user, and data associated with a proximity of a user to a predefined zero moment of truth.

4. The method of claim 1, wherein the processor selects a path from among the one or more matching paths using one or more parameters.

5. The method of claim 4 wherein the parameters comprise parameters selected from a group of conversion values, probabilistic conversion times, conversion types, and probability of conversion.

6. The method of claim 1, wherein the processor selects from the patterns in the database one or more matching paths using one or more clustering functions and using one or more parameters to extract one or more matching paths from a cluster.

7. The method of claim 1, wherein the determination of an action for the next engagement is in view of commercially relevant parameters.

8. The method of claim 1, wherein an action for the next engagement includes modifying a bid.

9. The method of claim 1 wherein the determination of an action for the next engagement includes modifying a channel of an advertisement to a mobile channel.

10. The method of claim 1 wherein the determination of an action for the next engagement includes modifying an advertisement presented to the user.

11. The method of claim 10 wherein modifying the advertisement presented to the user includes modifying one or more aspects of the advertisement, the aspects selected from the group consisting of creative, type, channel and targeting.

12. The method of claim 1 wherein the next engagement depends on a lifetime value of the user to an advertiser.

13. One or more non-transitory computer-readable media storing computer-readable instructions to manage a next engagement in a system comprising a memory storing a database of collected users' paths to conversion that, when executed by a processor, cause the processor to:
obtain a pattern comprising two or more interactions, with respect to a user;
compare the obtained pattern to patterns leading to conversion in the database, and to select one or more matching paths from the patterns leading to conversion; and,
to determine an action for the next engagement, the action for the next engagement configured to influence the user to choose a next action corresponding to an interaction in at least one of the selected matching paths.

14. The one or more non-transitory computer-readable media storing computer-readable instructions of claim 13, the instructions, when executed by the processor, further cause the processor to select from the patterns in the database one or more matching paths using one or more clustering functions.

15. The one or more non-transitory computer-readable media storing computer-readable instructions of claim 13, the instructions, when executed by the processor, further cause the processor to cluster the one or more clustering function groups of said obtained pattern with data, the data selected from the group consisting of data associated with a user path, data associated with an advertiser's product, data associated with a user, data associated with a prior history of the user, and data associated with a proximity of a user to a predefined zero moment of truth.

16. The one or more non-transitory computer-readable media storing computer-readable instructions of claim 13, the instructions, when executed by the processor, further cause the processor to select a path from among the one or more matching paths using one or more parameters.

17. The one or more non-transitory computer-readable media storing computer-readable instructions of claim 16, the instructions, when executed by the processor, further cause the processor to use parameters comprising parameters selected from a group of conversion values, probabilistic conversion times, conversion types, and probability of conversion.

18. The one or more non-transitory computer-readable media storing computer-readable instructions of claim 13, the instructions, when executed by the processor, further cause the processor to determine that an action for the next engagement is in view of commercially relevant criteria.

19. The one or more non-transitory computer-readable media storing computer-readable instructions of claim 13, the instructions, when executed by the processor, further cause the processor to modify a bid in the next engagement.

20. The one or more non-transitory computer-readable media storing computer-readable instructions of claim 13, the instructions, when executed by the processor, further cause the processor to modify an advertisement presented to the user.

21. The one or more non-transitory computer-readable media storing computer-readable instructions of claim 20 wherein modifying the advertisement presented to the user includes modifying one or more aspects of the advertisement, the aspects selected from the group consisting of creative, type, channel and targeting.

22. The method of claim 13, wherein the determination of an action for the next engagement includes modifying a channel of an advertisement to a mobile channel.

23. The one or more non-transitory computer-readable media storing computer-readable instructions of claim 13, the instructions, when executed by the processor, further cause the processor to determine the next engagement depending on a lifetime value of the user to an advertiser.

24. A system configured to manage a next engagement of a user, the system comprising a processor, the processor operatively coupled to a memory storing a database of collected users' paths to conversion, and configured to:
obtain a pattern comprising two or more interactions, with respect to a user;
compare the obtained pattern to patterns leading to conversion in the database, and to select one or more matching paths from the patterns leading to conversion; and,
to determine an action for the next engagement, the action for the next engagement configured to influence the user to choose a next action corresponding to an interaction in at least one of the selected matching paths.
